(19) United States
(12) Patent Application Publication
(10) Pub. No.: US 2014/0006417 A1
(43) Pub. Date: Jan. 2, 2014

(54) Method and Apparatus to Generate Ratings for a Tangible or Non-Tangible Object by Comparing Against Other Tangible or Non-Tangible Objects

(71) Applicant: Shubhendu Sekhar Mukherjee, Southborough, MA (US)

(72) Inventor: Shubhendu Sekhar Mukherjee, Southborough, MA (US)

(73) Assignee: Shubhendu Sekhar Mukherjee, Southborough, MA (US)

(21) Appl. No.: 13/539,479

(22) Filed: Jul. 1, 2012

(51) Int. Cl. G06F 17/30

(52) U.S. Cl. 707/748; 707/E17.014

(57) ABSTRACT

To create a rating of a tangible or non-tangible object, raters grade the object against another object with respect to an attribute. Multiple such grades are collected in a computing system. These grades are combined to create a single numeric score, which serves as the rating, for the object or object-attribute pair. This method of rating an object is superior to obtaining absolute numeric scores about a particular object or object-attribute pair because this method accurately reflects how an object ranks with respect to other objects.

### REFERENCES CITED

2010/7840563 B2 November 2010 Powers . . . 707/736
2011/7979300 B2 July 2011 Chandra . . . 705/7.29
2008/0027925 A1 January 2008 Li . . . 707/5
2010/0082566 A1 April 2010 Wang . . . 707/705
2010/0169324 A1 July 2010 Shnitko . . . 707/748
2011/0119264 A1 May 2011 Hu . . . 707/728

Present day method for ranking targets with respect to one another typically involves assigning an absolute score—also called a rating—to the particular target and then comparing the targets' absolute ratings to obtain a ranking of how targets compare with one another. For example, in one embodiment of this invention, a consumer could compare two different watches with absolute scores of 4 and 5, respectively, and decide that the one with the score of 5 is a better watch to purchase. Unfortunately, the absolute scores themselves could have biases of a person's own ranking and the environment the ranking was done in. Worse, the two targets being compared may not have been ranked by the same group of people, often causing the ranking to bemisleading.

Rating and ranking targets have long been used for various purposes. A consumer may make a purchase decision based on the absolute rating of a particular camera. Alternatively, a consumer may compare the ratings of two different cameras—thereby ranking them—and then buy the one with the higher rank. Such ratings and rankings are routinely used in all aspects of our lives now. For example, corporations use ratings and rankings of employees to determine compensation and raises. Journals use peer ratings and rankings of scholarly articles to decide which articles to publish. Wines are routinely rated—both by experts, such as Robert Parker, or non-experts, such as users on cellartracker.com—on a 0-100 point scheme with wines greater than 85 points usually considered good wines.

Typically, a ranking of different targets is derived out of their absolute ratings. For example, in many tests students will be given a score based on their performance. Say three students get the following scores or ratings (higher being better): 95, 85, and 75. Then, the student with the highest score or rating of 95 will be considered to be the best or having the highest rank among all the students. This simple method converts ratings to ranks, which works very well where the ratings can be determined with some degree of accuracy.

Unfortunately, this simple method of converting ratings to rankings has several drawbacks. First, the absolute scale for rating is often subject to people's biases. For example, one person may tend to grade targets higher and another person may grade everything lower. Using such ratings to create comparative rankings will be fraught with inaccuracy. If, however, enough ratings exist, then one could hope that the ratings could be normally distributed. Then, comparing the average rating to create comparative rankings would be appropriate. It is not clear that such ratings are normally distributed around an appropriate mean. Neither does this apply when the number of available ratings is small (e.g., <10).

Second, consumers often use different criteria to judge a target. For example, two wines may be rated 90 points by consumers because of different reasons. The first one could be a Bordeaux style wine that may have been rated at 90 points because of its aroma and long-lasting value. However, the other wine could be new age Pinot Noir and could be rated at 90 points because of its immediate drinkability. Comparing these two wines become difficult because they have been graded with different criteria in mind. A consumer may still want to find the ranking between these two wines to make a purchase decision from a wine store.

Third, the two targets being compared may not have been rated by the same or same group of consumers. In the example above, the Bordeaux may have been rated by Bordeaux drinkers who love “old age” wines, whereas the Pinot Noir may have been rated by consumers who love “new age” wines. Consequently, extracting the relative ranking between these two wines purely from their ratings may be difficult.

Fourth, using absolute ratings to create relative rankings is fraught with another slightly subtle difficulty. When comparing two targets, we are in effect, engaging them in a duel. A target XX should presumably gain a higher score if it wins against a stronger target YY instead of winning against a weaker target ZZ. For example, if a Porsche Boxter wins against a BMW Z4 (that is gets a higher rank), that may not be that much of a surprise, but if a Porsche Boxter wins against a Lamborghini Aventador, then the Boxter's relative rating should be higher than what it may obtain by dueling against a BMW Z4. This relative rating is not captured with ratings based on absolute scores.

Chess players and other garners had faced this similar predicament of converting ratings to rankings. In fact, there are situations when there is no rating available. When two players play a game, the only available outcomes for a player could be a win, a loss, or a draw. Given the outcome of a game, one would like to create a rating for a chess player, so that her rating may be used to see her standing against other players. For example, a chess grandmaster may need a rating of at least 2500. Chess ratings, in particular, have evolved over time. Also, different chess organizations use slightly different versions of the rating system. The “Elo Rating System” is a widely accepted rating system that forms the basis of many rating systems for chess, various games, and possibly the politically incorrect Facemash software that attempted to rank a person based on his/her “hotness” . The Elo Rating system is described in this disclosure only as an example rating system. Any other rating system could be used to create the relative ranking desired among targets.

The appeal of the Elo and other related rating systems is their use of the expected outcome when a target is compared to another target. In the Elo rating and ranking system, a player X's rating R′ is defined as:

Rₓ′=Rₓ+K.(Sₓ−Eₓ)

where R is the player X's current rating, Sₓ is the actual score of the player, Eₓ is actual score, and K is a scaling factor that adds relative weights to the (Sₓ−Eₓ) component. K is usually defined by some committee and may have different values for different Rs. As may be obvious, the new rating of a player R′ is based on her current rating R and how many games she actually wins or loses compared to the expected number of wins and losses she should have had. In one embodiment, Eₓ could be computed as Qₓ/(Qₓ+Q_{y}), with Qₓ= ^{Rx/400}. When a player joins the league, it is assigned an initial rating, which is updated as she gathers her score against other players.

Let us look at an example. Suppose Player X has a rating of 1700. She plays against 3 players with ratings 2100, 1600, and 1400. She wins against the first player, draws the second, and loses against the third. Her actual score=1+0.5+0=1.5. Her expected score (using the formula for Eₓ given above)=0.057+0.519+0.773=1.349. Assuming a K=30, we get player X's new rating as 1700+30 (1.5−1.349)=1705.

Such rating and ranking system in which the outcome of a “game” between two players is used to update the rating of a player and derive the ranking among players has not, however, been used to rank different targets. The only known example is Facemash, which presented the faces of two people on a computer screen to a user. The faces of people were the “targets.” The user had to rate which of the two people was hotter. In effect, one of the two faces would win and the other would lose. Using such a “duel” or “game” between two faces, Facemash built a rating of female students in the Harvard campus and derived relative ranking from these ratings. The Facemash algorithm has not been published, but it is rumored that it uses a system similar to the Elo rating.

Applying something like an Elo rating to a target, such as a watch, presents interesting challenges and opportunities. The Elo rating system only compares a single attribute or use case of a target. A watch, however, can have multiple attributes and use cases. For example, a watch could serve as a timekeeper as well as jewelry. When it serves as a timekeeper, it could be compared with clocks and other timekeeping instruments in terms of its accuracy. When a watch serves as jewelry, it could be compared against other bracelets in terms of its craftsmanship. So, when a target must “duel” against another target it must be based on a specific use case or a specific attribute.

### SUMMARY OF INVENTION

This invention solves the problem of creating accurate ratings from relative rankings for specific attributes across multiple tangible or non-tangible objects. Such relative rankings are derived from comparisons of different or similar tangible or non-tangible objects by individual raters. Comparisons can be performed pair-wise—that is, taking two objects and comparing them along an attribute to decide an outcome. Comparisons can also be performed across multiple targets along a single attribute to derive a partial ordering of the targets. This partial ordering serves as the outcome. Such numeric outcomes are then combined with various procedures, such as the Elo rating system, into creating accurate ratings for each of the targets. What outcomes to combine to create the rating depend on what subset of outcomes is selected. One choice would be to include all outcomes. Another choice would be include a subset of comparisons from one's friends or experts.

In one embodiment of the invention, the list of raters, attributes, and targets can reside in a single computer system. Alternatively in another embodiment of the invention, these lists can reside across multiple computer systems and connected together via some interconnection network.

### BRIEF DESCRIPTION OF THE SEVERAL VIEWS OF THE DRAWINGS

Having thus described the background of the invention in general terms, reference will now be made to the accompanying drawings, which are not necessarily drawn to scale, and wherein:

FIG. 1 is a diagram of a computer system constructed in accordance with an embodiment of the invention and includes both a volatile storage, such as DRAM, and non-volatile storage, such as hard drives and solid state disks. Each block, such as processor 100, only represents the device logically. An actual silicon chip may include only part of each block. Alternatively, a silicon chip may also include multiple logical blocks within a single chip or package. Target lists, attribute lists with scores, rater lists with scores, and slicers may be stored either in volatile storage or in non-volatile storage of this computer system.

FIG. 2 is a diagram of list of targets with associated attributes and scores from FIG. 1.

FIG. 3 is a diagram of attribute lists with scores and corresponding rater lists. Each rater list entry has the outcome from comparing two targets.

FIG. 4 is a diagram of the rater lists with corresponding slicers.

FIG. 5 is a diagram of the computer system from FIG. 1 containing the target lists, attribute lists, rater lists, and slicers in DRAM.

FIG. 6 shows a possible flow of operations to create and use the rankings of various targets.

FIG. 7 is a diagram of a computer system with multiple computer subsystems with target lists, attribute lists, rater lists, and slicers split across multiple computer subsystems.

### DETAILED DESCRIPTION OF THE INVENTION

Embodiments of the present inventions now will be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements. It will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

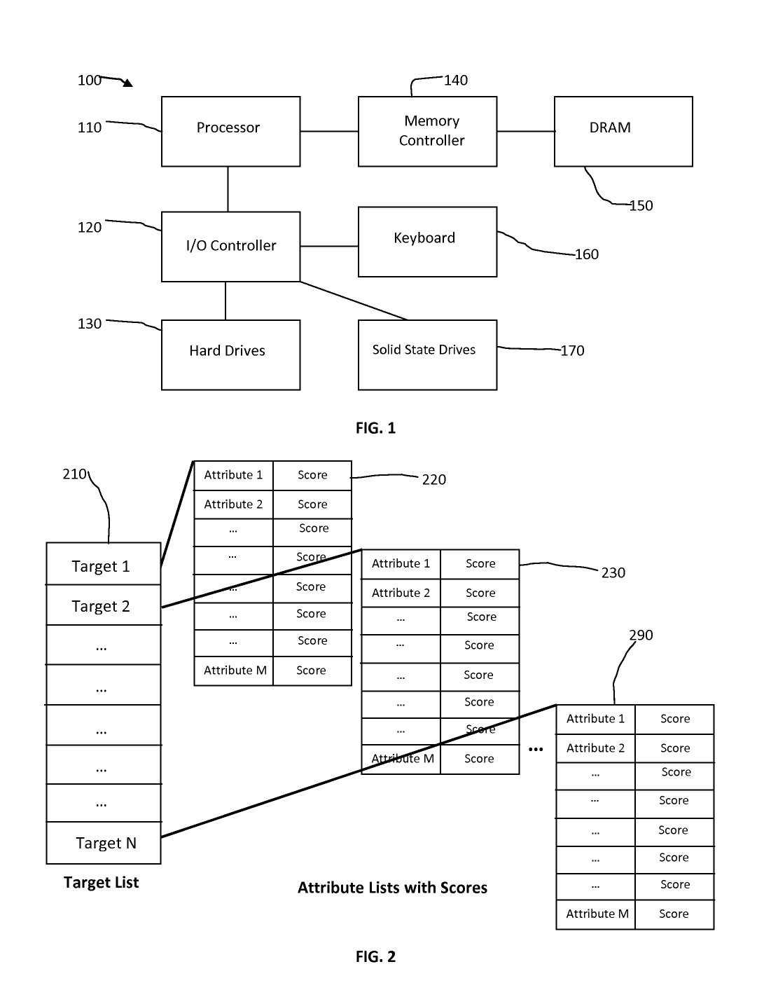

FIG. 1 shows a computer system 100 constructed in accordance with an embodiment of the invention. Computer system 100 includes a processor 110 connected to DRAM 150 via a memory controller 140. The processor 110 is also connected to a keyboard 160 and other peripheral devices (not shown in figure), hard drives 130, and solid state drives 170 via an I/O controller 120. FIG. 1 only shows logical boundaries of processors, memory, and drives. In an actual embodiment, some of these pieces can be combined into a single chip. For example, processor 110 and memory controller 140 may reside on the same single chip.

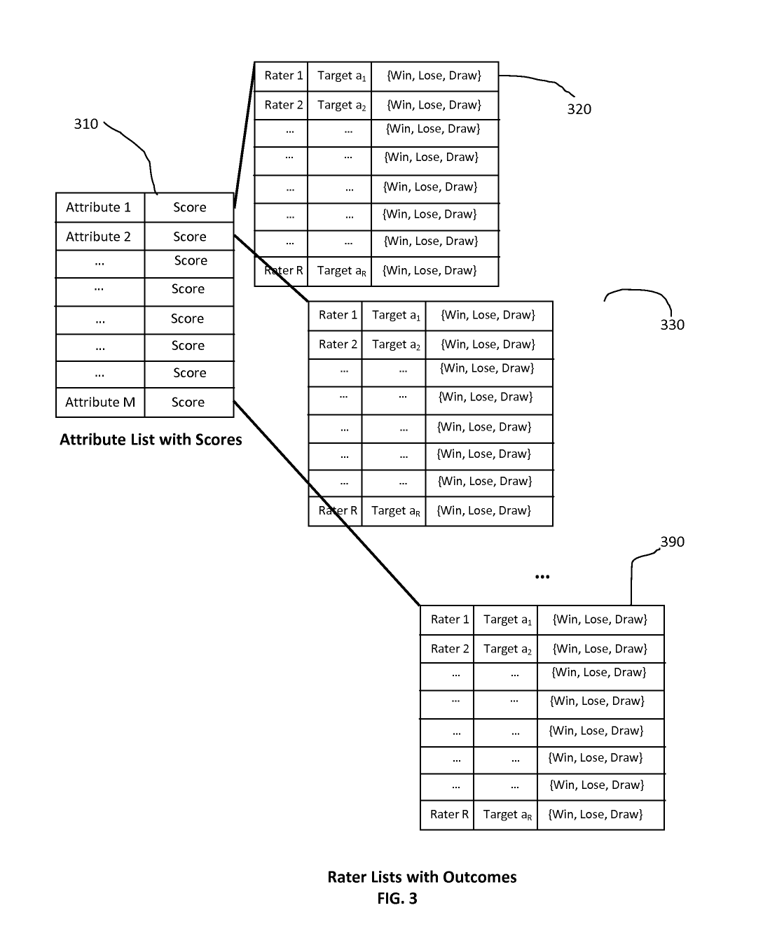

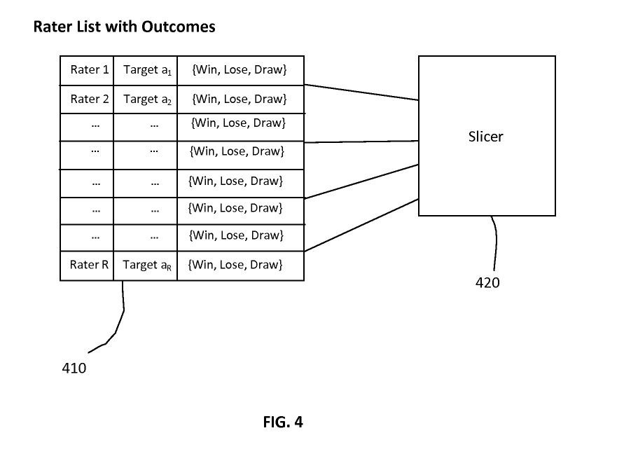

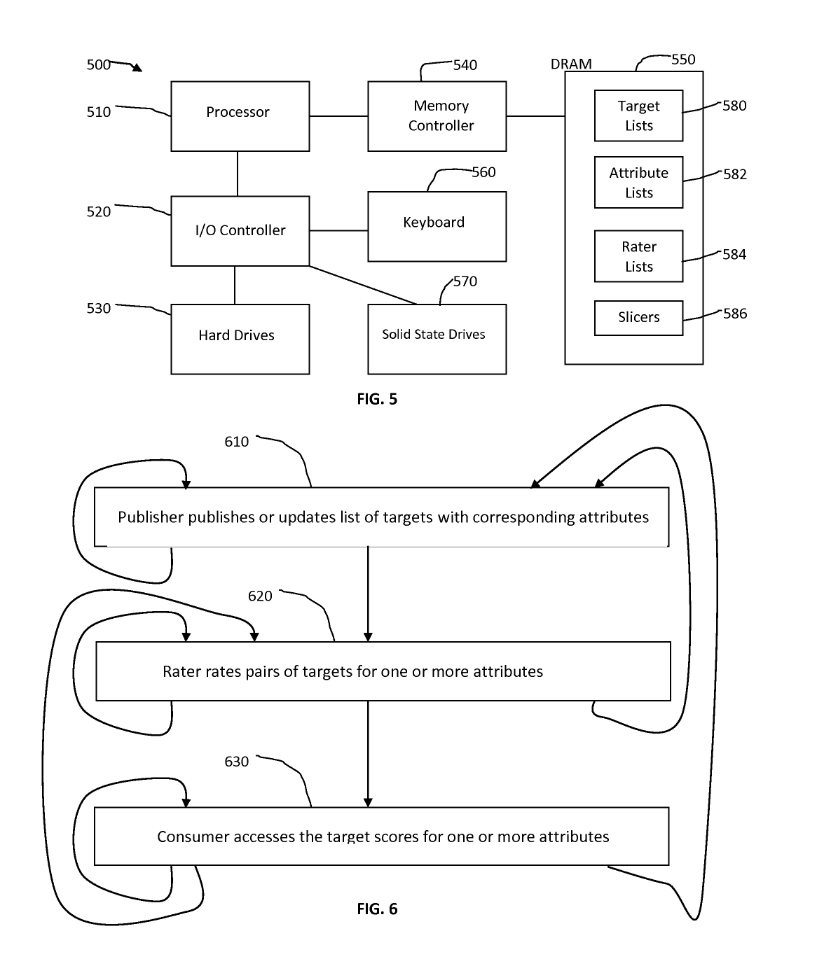

FIG. 2, FIG. 3, and FIG. 4 show several lists that can be stored in any convenient format in either volatile or non-volatile memory in the computer system of FIG. 1. A convenient format for an embodiment of the present invention can include, but is not limited to, a sequence of bits in disks or memory, compressed sequence of bits using any compression algorithm, such as Lempell-Ziv-Welsh, or encrypted sequence of bits encrypted using any encryption algorithm, such as AES. FIG. 5 shows one embodiment of the present invention in which the lists are stored in DRAM 550.

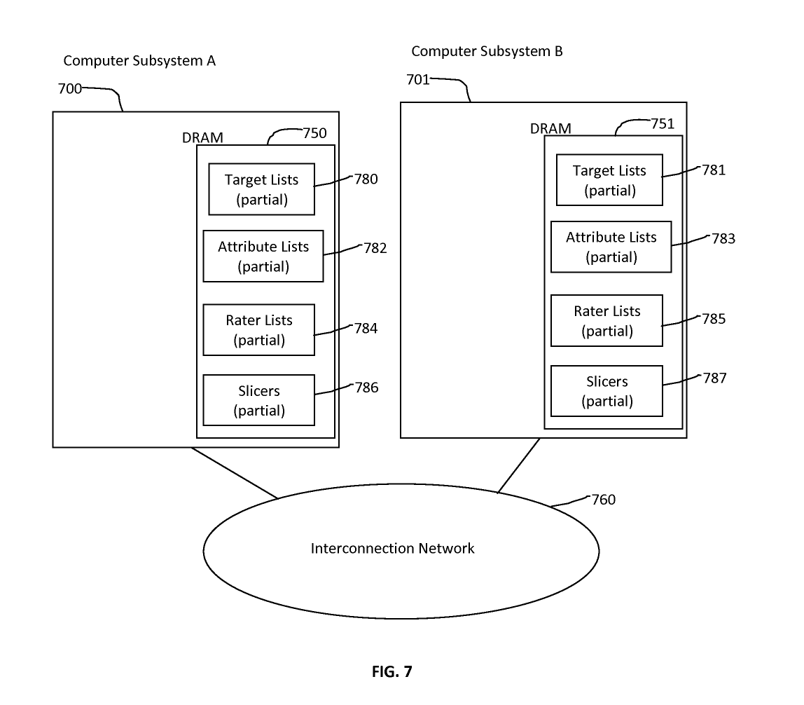

FIG. 2 shows a list of targets created with one embodiment of the present invention. The list of targets 210 can be created by one or more publishers as shown in FIG. 6 in step 610. Each entry in the target list 210 can contain or point to an attribute list, such as attribute list 220, attribute list 230, or attribute list 290. Each attribute list will contain a list of attributes with corresponding scores. For example, one target could be a specific wristwatch manufactured by a specific company, such as Rolex, with attribute 1 being timekeeping function, attribute 2 being how it looks, attribute 3 being how comfortable it is to wear, etc. The score for each attribute will be derived from the rater lists as described below.

The present invention includes various operations that can be performed to combine the scores of various attributes into one single score that consumers can use to rank each target against other targets. The simplest function may be the average or arithmetic mean of scores of two or more attributes for a specific target. Other such functions or operations can include, but are not limited to, median, geometric mean, harmonic mean, weighted forms of these means (in which each attribute is assigned a specific weight), maximum, and minimum.

FIG. 3 shows an attribute list 310 for a specific target (say T), as described in FIG. 2. Each attribute has a score derived out of a rater list 320, 330, or 390. For example, Attribute 1's score in attribute list 310 may be derived from Rater List 320. Each rater in rater list 320, 330, or 390 will compare attribute 1 for the specific target T against Target a₁, Target a₂, etc. Each rater can be a human or a non-human agent. By comparing two targets for a specific attribute, Rater 1 can assign a win, lose, or draw score to Target T's Attribute 1. For example, Rater 1 could be comparing a Rolex wristwatch (a target) with an Omega wristwatch (another target) with respect to accuracy of timekeeping function. Based on this comparison and Rater 1's own experience, Rater 1 could suggest that the Rolex wins over the Omega wristwatch and assigns it a “win” score. The same procedure can be followed by several raters leading to a rater list with duels performed for a Target T and specific attribute against multiple other targets. Then, these dueling scores (win, lose, or draw) can be combined using various rating systems, such as the ELO rating system, described earlier in this disclosure to create a score for Target T's Attribute 1. Similarly, Attribute 2, Attribute 3, etc. can be evaluated and scored by various raters.

Unlike the Facemash rating system or the rating system used in games, such as chess, the present invention duels multiple attributes of a target against attributes of various other related or unrelated targets. For example, Facemash would duel two women and ask the rater to decide which of the two is hotter? Similarly, in a chess rating system, the outcome of a duel or game is determined by a game of chess between two chess players. In both Facemash and chess rating systems, the duel is between similar or related targets with singular attributes. In contrast, the present invention may allow the “poise” (attribute) of a female human model (target) to be compared against the “poise” of a chimpanzee (another target). Similarly, the present invention may allow the “intelligence” (attribute) of a chess grandmaster (target) to be compared against the “intelligence” of a football quarterback (another target). Thus, the present invention allows for a powerful combination of targets, attributes, and scores.

Although FIG. 3 shows {win, lose, draw} as three possible outcomes, various embodiments of the present invention can use other possible outcomes, such as a scoring system from 1 to 10. For example, instead of voting that a specific Rolex wristwatch is better than another Omega wristwatch for accuracy of timekeeping, a rater could rate a Rolex wristwatch being 3 points better than the Omega wristwatch by assigning it a score of 8, where a score of 5 denotes no difference or a draw. Such point system can be used by ELO rating or other outcome-combining systems to create a final score the specific attribute. The ELO rating system, in such a case, would use these scores, instead of 1 for a win, 0.5 for a draw, and 0 for a loss.

FIG. 4 shows how a slicer can be used to slice the rater lists appropriately to feed into a rating system, such as the ELO rating system. Normally, one could pick all the entries 1 through R to decide on the score for a specific attribute. However, one could use various “slicers” to prune this list. For example, a consumer could identify a set of his or her friends and he or she may want to extract the portion of the rater list 410 that only pertain to his or her friends. Similarly, one could slice the rater list based on experts vs. non-experts. For example, when comparing wines, one could use ratings for an individual expert, such as Robert Parker, multiple experts, such as both Parker and Wine Spectator, or non-experts, such as consumers from cellartracker.com.

FIG. 5 shows an embodiment of the present invention in which the computer system of FIG. 1 is depicted. In this particular instance, the target lists 580, attribute lists 582, rater lists 584, and slicers 586 are stored in DRAM 550.

FIG. 6 shows an overall flow of steps to create this rating system. Step 610 involves a publisher that publishes or updates the targets lists with its corresponding attributes. For example, a publisher could publish a new target, such as a new tablet with its various attributes. Step 620 involves various raters rating a target against another target for a particular attribute. Step 630 involves the consumer accessing these lists and obtaining the scores for various attributes or a function of the scores (e.g., arithmetic mean) of the scores of various attributes for a target. The consumer can optionally apply appropriate slicers to choose whose scores he or she wants to include in the ratings he or she wants to obtain.

FIG. 7 shows another embodiment of the present invention where two computer subsystems 700 and 701 are connected via an interconnection network 760. The target list is split across two partial target lists 780 and 781. The attribute list is split across two partial attribute lists 782 and 783. The rater list is split across two partial rater lists 784 and 785. Similarly, the slicer is split across two partial slicers 786 and 787. Other embodiments of the present invention can include, but are not limited to, a plurality of computer subsystems and interconnection networks.

What is claimed is:

1. An apparatus for generating a numeric score for a tangible or non-tangible object from a computer system comprising:
a. a processor;
b. a system memory and non-volatile storage coupled to the said processor;
c. a rater list residing in the said system memory or said non-volatile storage and comprising of multiple entries, wherein each of the said rater list entries further comprises:
a. the said object name or number;
b. an attribute name or number;
c. a rater name or number;
d. one or more different object names or numbers being compared against; and
e. a numeric outcome of the comparison between the said object and the said different objects being compared with; and
wherein the said numeric outcome from the said rater denotes whether the said object is better, same, or worse than the said different object being compared with for the said attribute; and
d. an attribute list residing in the said system memory or said non-volatile storage and comprising of multiple entries, wherein each of the said attribute list entries further comprises:
a. the said object name or number; and
b. the said attribute name or number;
wherein a numeric score is computed for each attribute for the said object such that the said numeric score denotes an overall rating for the said object computed from the said numeric outcomes of each said entry in the said rater list.

2. The apparatus as defined in claim 1 further comprising of a single numeric score for an object as a function of part or all of the said numeric scores of each of the said object's said attributes.

3. The apparatus as defined in claim 1 further comprising of a method to pick a subset of the said rater list entries to compute the said numeric score for the said attribute.

4. The apparatus as defined in claim 3 wherein the subset of the said rater list entries comprise of entries picked by said raters that appear in a friends list resident in the said system memory or said non-volatile storage.

5. The method as defined in claim 3 wherein the subset of the said rater list entries comprise of entries picked by said raters that appear in an experts list resident in the said system memory or said non-volatile storage.

6. An apparatus for generating a numeric score for the said tangible or non-tangible object from a computer system comprising:
a. plurality of processors connected with one or more interconnection networks;
b. a system memory and non-volatile storage coupled to each of the said processors;
c. a rater list residing in one or more of the said system memories or said non-volatile storage devices and comprising of multiple entries, wherein each of the said rater list entries further comprises:
a. the said object name or number;
b. an attribute name or number;
c. a rater name or number;
d. one or more different object names or numbers being compared against; and
e. a numeric outcome of the comparison between the said object and the said different objects being compared with; and
wherein the said numeric outcome from the said rater denotes whether the said object is better, same, or worse than the said different objects being compared with for the said attribute; and
d. an attribute list residing in one or more of the said system memories or said non-volatile storage devices and comprising of multiple entries, wherein each of the said attribute list entries further comprises:
a. the said object name or number;
b. the said attribute name or number;
wherein a numeric score is computed for each attribute for the said object such that the said numeric score denotes an overall rating for the said object computed from the said numeric outcomes of each said entry in the said rater list.

7. The apparatus as defined in claim 6 further comprising of a single said numeric score for an object as a function of part or all of the said numeric scores of each of the said object's said attributes.

8. The apparatus as defined in claim 6 further comprising of a method to pick a subset of the said rater list entries to compute the said numeric score for the said attribute.

9. The apparatus as defined in claim 8 wherein the subset of the said rater list entries comprise of entries picked by said raters that appear in a friends list resident in one or more of the said system memories or said non-volatile storage devices.

10. The apparatus as defined in claim 8 wherein the subset of the said rater list entries comprise of entries picked by said raters that appear in an experts list resident in one or more of the said system memories or said non-volatile storage devices.

11. A method for generating a numeric score for the said tangible or non-tangible object from a computer system comprising of the steps:
a. connecting a plurality of processors with one or more interconnection networks;
b. connecting a system memory and non-volatile storage to each of the said processors;
c. storing a rater list in one or more of the said system memories or said non-volatile storage devices and comprising the said rater list of multiple entries, wherein each of the said rater list entries further comprises:
a. the said object name or number;
b. an attribute name or number;
c. a rater name or number;
d. One or more different object names or numbers being compared against; and
e. a numeric outcome of the comparison between the said object and the said different objects being compared with; and
wherein the said numeric outcome from the said rater denotes whether the said object is better, same, or worse than the said different objects being compared with for the said attribute; and
d. storing an attribute list in one or more of the said system memories or said non-volatile storage devices and comprising the said attribute list of multiple entries, wherein each of the said attribute list entries further comprises:
c. the said object name or number;
d. the said attribute name or number;
wherein a numeric score is computed for each attribute for the said object such that the said numeric score denotes an overall rating for the said object computed from the said numeric outcomes of each said entry in the said rater list.

12. The method as defined in claim 11 further comprising of a computing a single said numeric score for an object as a function of part or all of the said numeric scores of each of the said object's said attributes.

13. The method as defined in claim 11 further comprising of a method to pick a subset of the said rater list entries to compute the said numeric score for the said attribute.

14. The method as defined in claim 13 wherein the subset of the said rater list entries comprise of entries picked by said raters that appear in a friends list resident in one or more of the said system memories or said non-volatile storage devices.

15. The method as defined in claim 13 wherein the subset of the said rater list entries comprise of entries picked by said raters that appear in an experts list resident in one or more of the said system memories or said non-volatile storage devices.
